(19) United States
(12) Patent Application Publication
(10) Pub. No.: US 2019/0355195 A1
(43) Pub. Date: Nov. 21, 2019

(54) USE METHOD OF SMART BLUETOOTH LOCK

(71) Applicant: Zemin Hu, Xiangtan (CN)

(72) Inventor: Zemin Hu, Xiangtan (CN)

(21) Appl. No.: 15/990,827

(22) Filed: May 29, 2018

(30) Foreign Application Priority Data
May 17, 2018 (CN) 201810475820.4

(51) Int. Cl. G07C 9/00; E05B 45/06

(52) U.S. Cl. CPC G07C 9/00309; E05B 47/0001; E05B 45/06

(57) ABSTRACT

The disclosure claims a use method of a smart Bluetooth lock, which comprises the following steps of: Firstly, searching a Bluetooth Lock APP in a smart phone, registering as a user by using the phone number, logging in, and then tapping Add Device-Door Lock Model; Secondly, binding a selected door lock by binding a communication gateway at first, tapping “Add Start”, charging the gateway and inserting a network cable therein until a blue indicator light of the gateway keeps flashing, tapping “Next”, scanning a QR code on the gateway to bind the communication gateway, proceeding to a second step of binding the door lock after the gateway is successfully bound, opening an inner panel of the door lock to long press a “Function” key for 2 s and then release, and waiting for the door lock to send out a “Di” sound; Lastly, setting an admin password.

### TECHNICAL FIELD

The disclosure relates to the technical field of smart locks, in particular to a use method of a smart Bluetooth lock.

### BACKGROUND OF THE DISCLOSURE

Smart lock has actively promoted the popularization and landing of smart door locks in China, and successively established cooperative relationships with many well-known brands in the fields of real estate industry, hotel industry, elderly care industry, education industry, operators and service providers. The difference between the smart lock and Internet smart lock is that the smart lock refers to a smart lock which can be unlocked with a mobile phone remotely. A lock which is unlocked not through Internet connection should not be called Internet smart lock, but smart lock. In the future, it will be a set of smart lock system, which consists of a smart lock, a control center equipped with a gateway, and a smart switch, etc. It is possible to realize that the switch in the home can be automatically enabled by identifying the owner's fingerprint. Smart locks have been developed in China for more than ten years. In the past few years, smart locks have begun to develop and popularize at a very high speed. At present, people in many residential areas in China have chosen smart locks for one simple reason that the opening a door by fingerprint will definitely replace opening a door by key. This is a major development direction. Of course, the “security, stability, universality and intelligence” should be focused on when buying smart locks.

Existing electronic locks are generally unlocked by requiring a special induction cards or a remote controller or by entering password through a keypad, etc., which have the disadvantages of low level of intelligence, low security due to unlocking by a single password, inconvenient use and management, etc. Even biometric electronic locks with a relatively high level of intelligence also have the disadvantages of high mistake rate and inconvenient management.

### SUMMARY OF THE DISCLOSURE

An objective of the disclosure is to provide a use method of a smart Bluetooth lock to solve the problems raised in the background.

In order to achieve the above objective, a technical solution provided by the disclosure is as follows: a use method of a smart Bluetooth lock includes the following use steps of:

a. first searching a Bluetooth Lock APP in an application store of a smart phone, registering as a user by using the number of the smart phone, logging in after registration, and then tapping Add Device-Door Lock Model;

b. starting binding a selected door lock after completion of the step a by binding a communication gateway at first, tapping “Add Start”, charging the gateway and inserting a network cable therein until a blue indicator light of the gateway keeps flashing, tapping “Next”, scanning a QR code on the gateway to bind the communication gateway, proceeding to a second step of binding the door lock after the gateway is successfully bound, opening an inner panel of the door lock to long press a “Function” key for 2 s and then release, and waiting for the door lock to send out a “Di” sound;

c. setting an admin password after completion of the step b;

d. adding a fingerprint into the Bluetooth Lock APP after completion of the step c;

e. tapping a device name “Touch” after completion of the step c; tapping Touch-+ to add a new member of the door lock, filling in information about the new member, and tapping “Add Confirmation”, and adding a fingerprint or password with reference to Add Step in an interface of door lock member details until the fingerprint/password is added successfully;

f. closing the Bluetooth lock after completion of the step e, and then testing with the smart phone;

g. after completion of the step f, first pressing an unlocking switch on a Bluetooth lock control module when the smart phone is put close to an electronic lock body to be unlocked during unlocking by the smart phone, so that the Bluetooth Lock APP on the smart phone is automatically connected to the Bluetooth lock control module on the electronic lock body through Bluetooth to identify and verify the password and then to enable an electric machine of the electronic lock body to unlock after confirmation of the correct password.

As a preferred embodiment of the disclosure, the admin password set in the step c is a number with 6 digits.

As a preferred embodiment of the disclosure, adding the fingerprint in the step d includes the following steps of:

h. first, tapping the device name “TOUCH” to enter a “TOUCH” device management interface, and tapping an administrator icon in the bottom left corner to enter the interface of door lock member details;

i. after completion of the step h, tapping “Finger Unlock-Add Fingerprint” to start adding the fingerprint; adding a new fingerprint as instructed;

j. after completion of the step i, setting a fingerprint name when the fingerprint is added successfully, and tapping “Save” so that the fingerprint is added successfully.

As a preferred embodiment of the disclosure, a fingerprint reader, which records the fingerprint by requiring the finger to be pressed down and released for several times, is located at a front end of a door handle.

As a preferred embodiment of the disclosure, when unlocking with the fingerprint, a user simply holds the handle at a position where the handle is pressed downward, so that its thumb naturally touches a position where a finger scanner is located, and the door lock acquires the user's fingerprint quickly to complete the unlocking within 0.4 s.

As a preferred embodiment of the disclosure, the smart Bluetooth lock comprises a controller which consists of a power supply, a feedback module, an alarm module and a conversion module; the feedback module is connected to a Bluetooth module which is connected to an identification module, the identification module is connected to the Bluetooth Lock APP which is connected to the smart phone, the conversion module is connected to an acquisition module, and the alarm module is connected to a loudspeaker.

As a preferred embodiment of the disclosure, the controller is connected to the power supply, the feedback module, the alarm module and the conversion module through power cords, respectively.

As a preferred embodiment of the disclosure, the controller is fixedly connected to the inside of the smart Bluetooth lock through rivets, and the loudspeaker is connected to the inside of the controller through rivets.

Compared with the prior art, the disclosure has the following beneficial effects:

The use method of a smart Bluetooth lock according to the disclosure has the advantages of convenient use, safety, reliability, convenient management, and low power consumption. The Bluetooth technology makes the smart phone become a key, which expands the application fields of smart phones, thereby further improving the security and intelligence of daily-use security products and facilitating use management.

### BRIEF DESCRIPTION OF THE DRAWINGS

Other features, objectives and advantages of the disclosure will become more apparent by reading the detailed description of non-limiting embodiments with reference to the following drawings:

FIG. 1 is a flow chart of an intelligent Bluetooth lock controller according to the disclosure.

### DETAILED DESCRIPTION OF THE PREFERRED EMBODIMENTS

In order to make the technical means, creative features, objectives and efficacy achieved by the disclosure easy to understand, the disclosure will be further described below with reference to specific embodiments.

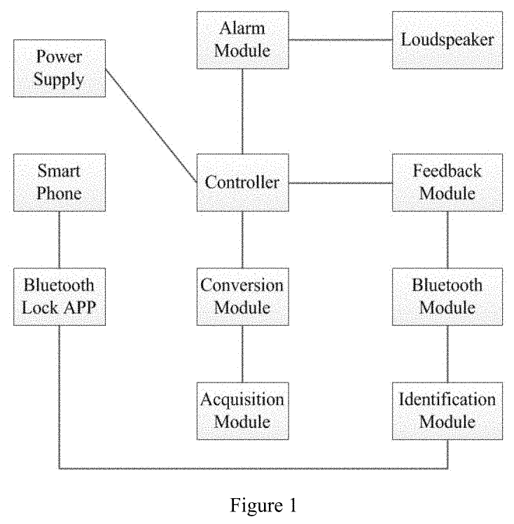

Please refer to FIG. 1. a technical solution provided by the disclosure is as follows: a use method of a smart Bluetooth lock includes the following use steps of:

a. first searching a Bluetooth Lock APP in an application store of a smart phone, registering as a user by using the number of the smart phone, logging in after registration, and then tapping Add Device-Door Lock Model;

b. starting binding a selected door lock after completion of the step a by binding a communication gateway at first, tapping “Add Start”, charging the gateway and inserting a network cable therein until a blue indicator light of the gateway keeps flashing, tapping “Next”, scanning a QR code on the gateway to bind the communication gateway, proceeding to a second step of binding the door lock after the gateway is successfully bound, opening an inner panel of the door lock to long press a “Function” key for 2 s and then release, and waiting for the door lock to send out a “Di” sound;

c. setting an admin password after completion of the step b;

d. adding a fingerprint into the Bluetooth Lock APP after completion of the step c;

e. tapping a device name “Touch” after completion of the step c; tapping Touch-+ to add a new member of the door lock, filling in information about the new member, and tapping “Add Confirmation”, and adding a fingerprint or password with reference to Add Step in an interface of door lock member details until the fingerprint/password is added successfully;

f. closing the Bluetooth lock after completion of the step e, and then testing with the smart phone;

g. after completion of the step f, first pressing an unlocking switch on a Bluetooth lock control module when the smart phone is put close to an electronic lock body to be unlocked during unlocking by the smart phone, so that the Bluetooth Lock APP on the smart phone is automatically connected to the Bluetooth lock control module on the electronic lock body through Bluetooth to identify and verify the password and then to enable an electric machine of the electronic lock body to unlock after confirmation of the correct password.

The admin password set in the step c is a number with 6 digits.

Adding the fingerprint in the step d includes the following steps of:

h. first, tapping the device name “TOUCH” to enter a “TOUCH” device management interface, and tapping an administrator icon in the bottom left corner to enter the interface of door lock member details;

i. after completion of the step h, tapping “Finger Unlock-Add Fingerprint” to start adding the fingerprint; adding a new fingerprint as instructed;

j. after completion of the step i, setting a fingerprint name when the fingerprint is added successfully, and tapping “Save” so that the fingerprint is added successfully.

A fingerprint reader which records the fingerprint by requiring the finger to be pressed down and released for several times is located at a front end of a door handle.

When unlocking with the fingerprint, a user simply holds the handle at a position where the handle is pressed downward, so that its thumb naturally touches a position where a finger scanner is located, and the door lock acquires the user's fingerprint quickly to complete the unlocking within 0.4 s.

The smart Bluetooth lock comprises a controller which consists of a power supply, a feedback module, an alarm module and a conversion module; the feedback module is connected to a Bluetooth module which is connected to an identification module, the identification module is connected to the Bluetooth Lock APP which is connected to the smart phone, the conversion module is connected to an acquisition module, and the alarm module is connected to a loudspeaker.

The controller is connected to the power supply, the feedback module, the alarm module and the conversion module through power cords, respectively.

The controller is fixedly connected to the inside of the smart Bluetooth lock through rivets, and the loudspeaker is connected to the inside of the controller through rivets.

During the use of a smart Bluetooth lock, it includes the following steps of first searching a Bluetooth Lock APP in an application store of a smart phone, registering as a user by using the number of the smart phone, logging in after registration, and then tapping Add Device-Door Lock Model; starting binding a selected door lock by binding a communication gateway at first, tapping “Add Start”, charging the gateway and inserting a network cable therein until a blue indicator light of the gateway keeps flashing, tapping “Next”, scanning a QR code on the gateway to bind the communication gateway, proceeding to a second step of binding the door lock after the gateway is successfully bound, opening an inner panel of the door lock to long press a “Function” key for 2 s and then release, and waiting for the door lock to send out a “Di” sound; setting an admin password, adding a fingerprint into the Bluetooth Lock APP, and then tapping a device name “Touch”; tapping Touch-+ to add a new member of the door lock, filling in information about the new member, and tapping “Add Confirmation”, and adding a fingerprint or password with reference to Add Step in an interface of door lock member details until the fingerprint/password is added successfully; closing the Bluetooth lock, and then testing with the smart phone; first pressing an unlocking switch on a Bluetooth lock control module when the smart phone is put close to an electronic lock body to be unlocked during unlocking by the smart phone, so that the Bluetooth Lock APP on the smart phone is automatically connected to the Bluetooth lock control module on the electronic lock body through Bluetooth to identify and verify the password and then to enable an electric machine of the electronic lock body to unlock after confirmation of the correct password.

The above embodiments describe the basic principle, main features, and advantages of the disclosure. It will be apparent to a person skilled in the art that the disclosure is not limited to the details of the foregoing exemplary embodiments, but can be embodied in other specific forms without departing from the spirit or basic features of the disclosure. Therefore, no matter from which point of view, the embodiments should be regarded as exemplary and not non-restrictive, and the scope of the disclosure is defined by the appended claims rather than by the above description. It is therefore intended to include in the disclosure all the changes which fall within the meaning and range of equivalents of the claims. Any reference signs in the claims should not be construed as limiting the claim involved.

In addition, it should be understood that although the specification is described according to the embodiments, not every embodiment only includes one independent technical solution. This description of the specification is merely for the sake of clarity and a person skilled in the art should take the specification as a whole and the technical solutions in the embodiments may also be properly combined to form other embodiments that can be understood by a person skilled in the art.

1. A use method of a smart Bluetooth lock, wherein it comprises the following steps of:
a. first searching a Bluetooth Lock APP in an application store of a smart phone, registering as a user by using the number of the smart phone, logging in after registration, and then tapping Add Device-Door Lock Model;
b. starting binding a selected door lock after completion of the step a by binding a communication gateway at first, tapping “Add Start”, charging the gateway and inserting a network cable therein until a blue indicator light of the gateway keeps flashing, tapping “Next”, scanning a QR code on the gateway to bind the communication gateway, proceeding to a second step of binding the door lock after the gateway is successfully bound, opening an inner panel of the door lock to long press a “Function” key for 2 s and then release, and waiting for the door lock to send out a “Di” sound;
c. setting an admin password after completion of the step b;
d. adding a fingerprint into the Bluetooth Lock APP after completion of the step c;
e. tapping a device name “Touch” after completion of the step c; tapping Touch-+ to add a new member of the door lock, filling in information about the new member, and tapping “Add Confirmation”, and adding a fingerprint or password with reference to Add Step in an interface of door lock member details until the fingerprint/password is added successfully;
f. closing the Bluetooth lock after completion of the step e, and then testing with the smart phone;
g. after completion of the step f, first pressing an unlocking switch on a Bluetooth lock control module when the smart phone is put close to an electronic lock body to be unlocked during unlocking by the smart phone, so that the Bluetooth Lock APP on the smart phone is automatically connected to the Bluetooth lock control module on the electronic lock body through Bluetooth to identify and verify the password and then to enable an electric machine of the electronic lock body to unlock after confirmation of the correct password.

2. The use method of a smart Bluetooth lock according to claim 1, wherein the admin password set in the step c is a number with 6 digits.

3. The use method of a smart Bluetooth lock according to claim 1, wherein adding the fingerprint in the step d comprises the following steps of:
h. first, tapping the device name “TOUCH” to enter a “TOUCH” device management interface, and tapping an administrator icon in the bottom left corner to enter the interface of Door lock member details;
i. after completion of the step h, tapping “Finger Unlock-Add Fingerprint” to start adding the fingerprint; adding a new fingerprint as instructed;
j. after completion of the step i, setting a fingerprint name when the fingerprint is added successfully, and tapping “Save” so that the fingerprint is added successfully.

4. The use method of a smart Bluetooth lock according to claim 1, wherein a fingerprint reader, which records the fingerprint by requiring the finger to be pressed down and released for several times, is located at a front end of a door handle.

5. The use method of a smart Bluetooth lock according to claim 1, wherein when unlocking with the fingerprint, a user simply holds the handle at a position where the handle is pressed downward, so that its thumb naturally touches a position where a finger scanner is located, and the door lock acquires the user's fingerprint quickly to complete the unlocking within 0.4 s.

6. The use method of a smart Bluetooth lock according to claim 1, wherein the smart Bluetooth lock comprises a controller which consists of a power supply, a feedback module, an alarm module and a conversion module; the feedback module is connected to a Bluetooth module which is connected to an identification module, the identification module is connected to the Bluetooth Lock APP which is connected to the smart phone, the conversion module is connected to an acquisition module, and the alarm module is connected to a loudspeaker.

7. The use method of a smart Bluetooth lock according to claim 1, wherein the controller is connected to the power supply, the feedback module, the alarm module and the conversion module through power cords, respectively.

8. The use method of a smart Bluetooth lock according to claim 1, wherein the controller is fixedly connected to the inside of the smart Bluetooth lock through rivets, and the loudspeaker is connected to the inside of the controller through rivets.
